(19) United States
(12) Patent Application Publication
(10) Pub. No.: US 2003/0155136 A1
(43) Pub. Date: Aug. 21, 2003

(54) Slopeboard

(76) Inventors: Clayton R. Carter, North Logan, UT (US); Jeremy A. Jenkins, Logan, UT (US); Layne W. Finlinson, Smithfield, UT (US); Roy A. Hales, Camarillo, CA (US)

Correspondence Address: FEHR LAW FIRM, Goldenwest Corporate Center, Suite 300, 5025 Adams Avenue, Ogden, UT, 84403, US

(21) Appl. No.: 10/079,792

(22) Filed: Feb. 19, 2002

(51) Int. Cl. A01B 79/00

(52) U.S. Cl. 172/1

(57) ABSTRACT

An improved slopeboard having a solid member with an inner pivotal mounting integrally formed as an aperture within the solid member near the first end of the solid member and with an outer pivotal mounting integrally formed as an aperture within the solid member near the second end of the solid member. In the case of a slopeboard having a moldboard and a framework having an outer pivotal mounting and an inner pivotal mounting, the solid member is attached to such framework. In the case of a slopeboard having a moldboard having an outer pivotal mounting and an inner pivotal mounting, the solid member is attached directly to the moldboard.

### BACKGROUND OF THE INVENTION

1. Field of the Invention

This invention relates to the structural construction and mounting positions of a slopeboard frame, which is a subsidiary blade, mounted on tractors commonly having a primary push blade, for earth or snow moving use.

Such tractors are most commonly termed bulldozers, a term which seems to have become generic for designating a crawler-mounted tractor equipped with a primary push blade, even though tractors which are propelled by means other than tracks, such as rubber tires, may carry a primary push blade.

The slopeboard enables the tractor to cut an angle on earth adjacent to the tractor, for example, to create the slope along the side of a road that cuts through a hill.

2. Description of the Related Art

Four patents are known to the inventors which apply to slopeboards, viz., U.S. Pat. Nos. 4,068,726; 4,079,791; 4,223,461; and 3,429,380.

All four of these patents utilize a fluid-powered cylinder to extend and retract a rod. The closed end of the cylinder is attached relatively high on the back of the primary push blade, although the point of attachment for the cylinder of U.S. Pat. No. 4,223,462 appears to be somewhat lower than the point of attachment in the case of the other three patents. The rod end of the cylinder is attached towards the outside point of the slopeboard, farthest away from the primary push blade. The inside edge of the slopeboard near the edge of the primary push blade is rotatably attached to the primary push blade. Therefore, extending the rod lowers the slopeboard; and retracting the rod raises the slopeboard.

The first three patents noted apply to slopeboards which mount on primary push blades which do not have support arms outside the tracks and wheels that propel the tractor. In fact U.S. Pat. No. 4,079,791 explicitly declares on lines 26 through 30 in column 2, “The sloping attachment (sometimes referred hereinafter as ‘sloper blade/board device’) as shown in FIG. 1 is mounted on any six way hydraulic angle and tilt bulldozer(s), with inside the track dozer arms . . . ”

Larger bulldozers, however, have large arms to hold the primary push blade. These large arms are located outboard of the wheels or tracks. Typically slopeboards which mount on tractors with these outboard arms are constructed of square tubular steel in a generally triangular frame configuration and are attached to the tractor in three locations. First, two hinged mounting lugs are attached to the arm. The hinged mounting lugs on the arm are independent but concentric. Second, a fluid-powered cylinder links the slopeboard to the primary push blade. The closed end of the cylinder attaches to the primary push blade. The rod end of the cylinder attaches to an independently located lug on the opposite side of the frame from the primary push blade.

Under the current design, as the slopeboard cylinder rod retracts, thus raising the slopeboard from a position somewhat level with the earth to a position somewhat perpendicular to the earth, a tremendous load is transferred through the slopeboard frame to the hinged mounting lugs located on the bulldozer arm. This action, coupled with forces of earthmoving can invariably stress the tubular frame to the point of fracture.

In addition, because of the independently located lugs on the slopeboard frame and dozer arms, precise control over the possible slopeboard range of motion may not be possible. With lack of precise control over the slopeboard's range of motion, the ability to grade at desired elevations may not be obtainable. Also, because the addition of a slopeboard to the tractor increases the overall width of the tractor, highway load width requirements may be compromised if the slopeboard can not be raised to a true vertical position.

The inventors of the present invention also have a copending nonprovisional application entitled “Slopeboard Mounting Linkage” Ser. No. 09/640,885 filed on Aug. 18, 2000. That application describes a slopeboard which mounts on the outboard dozer arms using a linkage which enables the slopeboard to travel from zero to ninety degrees.

### SUMMARY OF THE INVENTION

Tractors which typically carry slopeboard attachments are designed for high-capacity earthmoving. On the other hand, the slopeboard is designed for light grading and precise finish work. The slopeboard must be relatively lightweight in order not to damage the parent tractor and inconspicuous enough not to obstruct the tractor operator's field of vision, yet versatile enough to perform grading operations at a variety of elevations and then fold up vertical for highway transportation to the next job site.

The present invention significantly strengthens the structural slopeboard framework by incorporating the hinged mounting lug on the bulldozer arm with the cylinder rod lug located on the opposite side of the slopeboard frame in a solid steel beam. As the cylinder rod retracts, thus rotating the slopeboard to a more vertical position, the load is transferred directly through the solid steel beam to the hinged mounting lug on the bulldozer arm.

Additionally, the slopeboard range of motion is much more accurate because the two mounting locations are precisely located by precision machining during the manufacturing process. This allows the tractor operator to achieve the most complete range of grading elevations and to transport the tractor with the slopeboard truly vertical, in some cases avoiding highway load width limitations, costly permits, or fines.

### BRIEF DESCRIPTION OF THE SEVERAL VIEWS OF THE DRAWING

FIG. 1 portrays an isometric view from the rear of the slopeboard frame mounted on the left-hand side of the dozer arm and primary push blade. The actual tractor is not shown although the left half of the primary push blade and dozer arms are depicted. The slopeboard fluid power cylinder is shown fully extended with the slopeboard cutting edge level with the cutting edge on the primary push blade.

FIG. 2 shows the slopeboard in the same view as FIG. 1. The left-hand dozer arms, primary push blade, slopeboard fluid powered cylinder, and mounting lugs have been removed from this view for clarity.

FIG. 3 is a top view of the slopeboard.

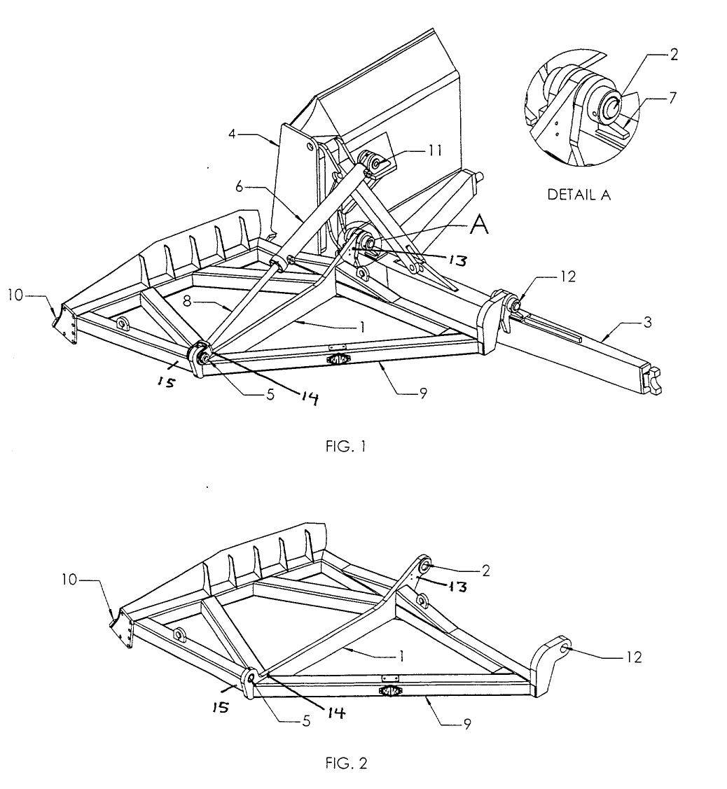

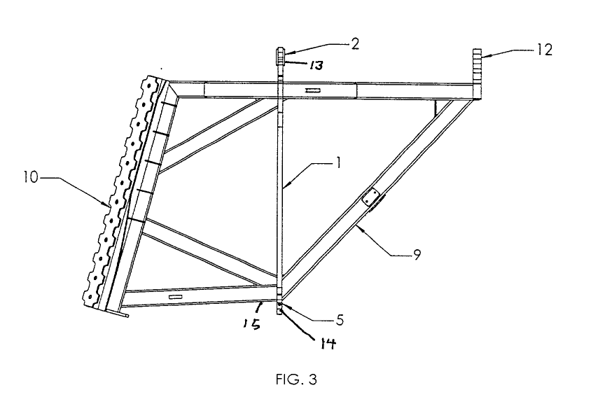

### DETAILED DESCRIPTION OF THE INVENTION

The preferred embodiment of the present Improved Slopeboard employs a solid member 1 which incorporates two pivotal mountings. The first or inner pivotal mounting 2 is attached to a mounting lug 7 which is attached to the tractor, preferably the dozer arm 3, or in some cases directly attached to the primary push blade 4 if outboard dozer arms are not present. The second or outer pivotal mounting 5 is connected at a mounting location on an outer portion 15 of the slopeboard framework 9 and is for a cylinder rod 8 which is extended and retracted in a fluidically or pneumatically powered cylinder 6. The closed end of the hydraulic cylinder 6 is attached to a pivotal mounting 11 which is attached to the tractor, preferably somewhere on the primary push blade 4. Thus, retracting the cylinder rod 8 into the cylinder 6, causes the slopeboard framework 9 which holds the moldboard and cutting edge 10 to rotate about pivotal mounting 2 and pivotal mounting 12. Pivotal mounting 12 is concentrically aligned with pivotal mounting 2; and both pivotal mounting 2 and pivotal mounting 12 are attached to the dozer arm 3 or, in some cases, the primary push blade 4.

The solid member 1 is preferably attached to a framework 9 which supports a moldboard and cutting edge 10 used for scraping and moving earth or snow. Some slopeboards, however, do not have a framework 9. In such a case, the solid member 1 is attached directly to the moldboard 10. The solid member 1 has a first end 13, the inner pivotal mounting 2 integrally formed as an aperture within the solid member 1 near the first end 13, a second end 14, and the outer pivotal mounting 5 integrally formed as an aperture within the solid member 1 near the second end 14.

The preferred construction material for the slopeboard framework 9 is square or rectangular steel tubing. The preferred construction material for the solid member 1 is steel with precisely machined pivotal mountings 2 and 5 to ensure accurate slopeboard range of motion.

The purpose of the solid member 1 is to transfer load directly to the pivotal mounting 2 as the cylinder 6 is actuated thus alleviating stress in the traditionally tubular slopeboard framework 9. In addition, when a framework 9 is employed, the solid member 1 stiffens the slopeboard framework 9 when the slopeboard moldboard and cutting edge 10 are under load during earth- or snow-moving operations. Also by using a solid member 1, it is possible to precisely link pivotal mountings 2 and 5 in a plane thus increasing the accuracy of the slopeboard's range of motion.

In currently available slopeboard designs, either the slopeboard framework 9 is completely open in the center where the solid member 1 of the present invention is located or the slopeboard framework 9 is stiffened, in the area where the solid member 1 of the present invention is located, only with tubing similar to that which is traditionally used on other portions of the slopeboard framework 9. In addition, under current practice the pivotal mounting 5 for the cylinder rod 8 is separately manufactured and attached to the slopeboard framework 9 which diminishes the accuracy in alignment of pivotal mountings 5 and 2. Also attaching pivotal mounting 5 independently to the slopeboard framework 9 transfers stresses inefficiently through the tubular framework 9 and increases the chances for structural fracture in the framework 9.

We claim:

1. An improved slopeboard, for use on a tractor having a primary push blade, of the type having a moldboard and a framework having an outer pivotal mounting and an inner pivotal mounting, wherein the improvement comprises:
a solid member attached to the framework, said solid member having a first end, the inner pivotal mounting integrally formed as an aperture within the solid member near the first end, a second end, and the outer pivotal mounting integrally formed as an aperture within the solid member near the second end.

2. The improved slopeboard as recited in claim 1, wherein:
the solid member is constructed from steel.

3. An improved slopeboard, for use on a tractor having a primary push blade, of the type having a moldboard having an outer pivotal mounting and an inner pivotal mounting, wherein the improvement comprises:
a solid member attached to the moldboard, said solid member having a first end, the inner pivotal mounting integrally formed as an aperture within the solid member near the first end, a second end, and the outer pivotal mounting integrally formed as an aperture within the solid member near the second end.

4. The improved slopeboard as recited in claim 3, wherein:
the solid member is constructed from steel.
